(19) United States
(12) Patent Application Publication
(10) Pub. No.: US 2026/0244535 A1
(43) Pub. Date: Aug. 20, 2026

(54) INFORMATION HANDLING SYSTEM WITH A MECHANISM TO PERFORM DIAGNOSTICS BASED ON NO VIDEO MODE REPORTED TRIGGERS

(71) Applicant: DELL PRODUCTS L.P., Round Rock, TX (US)

(72) Inventors: Venkata Rama Krishna Rao Atta, Hyderabad (IN); Ibrahim Sayyed, Georgetown, TX (US); Adolfo Montero, Pflugerville, TX (US)

(21) Appl. No.: 19/054,234

(22) Filed: Feb. 14, 2025

(51) Int. Cl. G06F 11/14; G06F 9/4401

(52) U.S. Cl. CPC G06F 11/1417; G06F 9/4401; G06F 2201/805

(57) ABSTRACT

An information handling system includes a system on a chip (SoC) that executes diagnostic boot operations in the information handling system. During the diagnostic boot operations, the SoC generates a diagnostic code during the diagnostic boot operations. The system monitors the boot operations being executed by the SoC, stores any boot markers received from the SoC and determines whether a time out event has occurred before a first boot marker is received or after a most recent boot marker. In response to a detection of the time out event, the system triggers the diagnostic boot operations.

### FIELD OF THE DISCLOSURE

The present disclosure generally relates to information handling systems, and more particularly relates to an information handling system with a mechanism to perform diagnostics based on no video mode reported triggers.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a system on a chip (SoC) that may execute diagnostic boot operations in the information handling system. During the diagnostic boot operations, the SoC may generate a diagnostic code during the diagnostic boot operations. The system may monitor the boot operations being executed by the SoC, and may store any boot markers received from the SoC and determine whether a time out event has occurred before a first boot marker is received or after a most recent boot marker. In response to a detection of the time out event, the system may trigger the diagnostic boot operations.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of portion of a system including multiple information handling systems, a charger adapter, a mobile device, and a remote server according to at least one embodiment of the present disclosure;

FIG. 2 is a flow diagram of a method for performing diagnostics based on no video mode reported triggers according to at least one embodiment of the present disclosure; and

FIG. 3 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

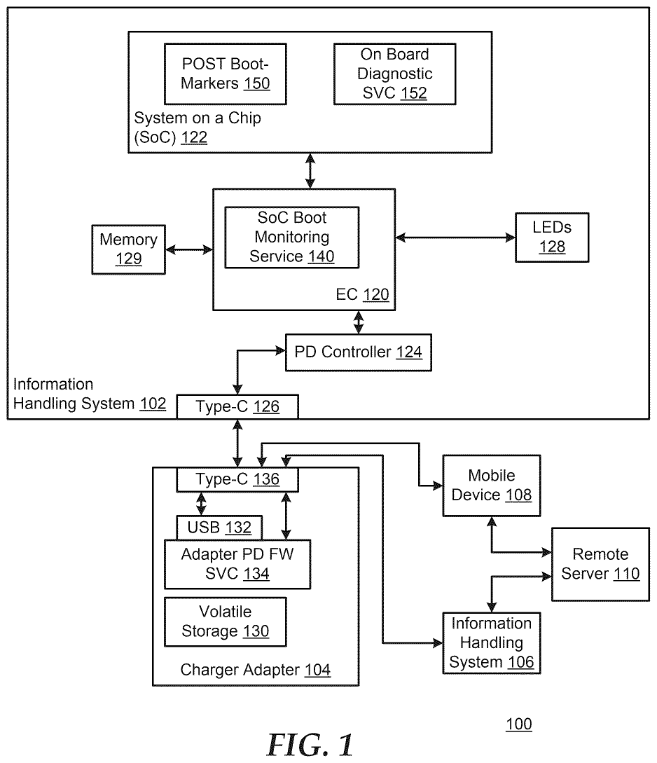

FIG. 1 illustrates a portion of a system 100 including an information handling system 102, a charger adapter 104, another information handling system 106, a mobile device 108, and a remote server 110 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 102 includes an embedded controller 120, a system on a chip (SoC) 122, a power delivery (PD) controller 124, a universal serial bus (USB) type-C connector 126, light emitting diodes (LEDs) 128, and a memory 129. Charger adapter 104 includes a volatile storage 130, a USB connector 132, an adapter PD firmware (FW) service 134, and a type-C connector 136. Embedded controller 120 includes a SoC boot monitoring service 140. SoC 122 includes power-on self-test (POST) boot markers 150 and an on-board diagnostic service 152. Information handling system 102 and charger adapter 104 may include additional components without varying from the scope of this disclosure.

During operations of a boot process in information handling system 102, embedded controller 120 may initialize SoC boot monitoring service 140, which may enable the embedded controller to monitor SoC 122 for different boot markers 150 of the boot process. In an example, the different boot markers 150 may indicate the completion of different phases or stages in the boot operations. These different phases or stages include, but are not limited to, power-on self-test (POST), boot sector search, boot loader execution, kernel loading, device driver initialization, and user interface launch. During the POST, SoC 122 may perform different phases including, but not limited to, a power supply check, a basic input/output system (BIOS) verification, a central processing unit (CPU) initialization, memory testing, device detection, interrupt controller check, time check, video initialization, and boot device selection.

In certain examples, SoC 122 may perform POST boot operations based on a BIOS image stored in memory 129. In an example, the BIOS image for SoC 122 may be designed with boot markers 150 at for every critical stage of the POST flow or process. These critical stages of the POST may be any stages of the POST, such as security (SEC), pre-extensible firmware interface (pre-PEI), driver execution environment (DXE), and boot device selection (BDS). In response to a boot marker stage during the POST being performed, the BIOS of SoC 122 may provide the corresponding boot marker 150 to embedded controller 120 over any available communication as per the SOC design.

In an example, embedded controller 120 may keep track of SOC 122 POST process through the received boot markers150. Embedded controller 120 may store the received boot markers 150 in memory 129. While monitoring the POST via SoC monitoring service 140, embedded controller 120 may determine whether each subsequent boot marker 150 is received before a timeout event has occurred. In response to the next boot marker 150 being received before the timeout event, embedded controller 120 may determine whether a boot marker 150 is the last boot marker for the POST process. In an example, embedded controller 120 may determine whether the received boot marker is the last boot marker based on a boot marker table stored in memory 129. In certain examples, the boot marker table may be created during the build time of the BIOS and embedded controller 120 of information handling system 102.

Embedded controller 120 may continuously perform a SoC boot monitoring loop which includes, but is not limited to, receiving a boot marker 150, storing the boot marker in memory 129, determining whether the timeout event has occurred, and determining whether the boot marker is the last boot marker. In an example, embedded controller 120 may exit the SoC boot monitoring loop if either the last boot marker is received or the timeout event occurred before the next boot marker 150 is received.

In response to embedded controller 120 detecting last boot marker 150, the embedded controller ends the monitoring loop and enables SoC 122 to continue the boot process to boot to the operating system of information handling system 102. In response to embedded controller 120 determining that the timeout event has occurred, the embedded controller ends the monitoring loop and generates a diagnostic boot trigger. In an example, the occurrence of the timeout event may indicate that the POST process of SoC 122 is stuck repeatedly on continuous power-ON button events. Additionally, based on the occurrence of the timeout event, embedded controller 120 may disable the power button of information handling system 102 and cause SoC 122 to enter a special boot, such as a diagnostic boot mode. In an example, user can use a hot key during the POST to force information handling system 102 in the headless diagnostic boot, such that SoC 120 may generate the diagnostic report while the information handling system is in a headless or no-video mode.

In response to the SoC diagnostic boot trigger, SoC 122 may enter a diagnostic boot mode. As first step of the POST phase in the diagnostic boot mode, SoC 122 may fetch the last boot marker stored in memory 129 via embedded controller 120. In an example, the last boot marker may be utilized as a POST failed boot marker code. After receiving the POST failed boot marker 150, SoC 122 may execute targeted diagnostics of the failed POST boot. In an example, diagnostics may be performed in any suitable diagnostics mode of information handling system 102, such as in a headless or no video (NV) mode. During this stage, embedded controller 120 may use any available LEDs 128, such as CAPSLOCK and NUMLOCK keys, to indicate to the user that information handling system 102 is in the recovery/diagnostic state. In an example, LEDs 128 may continuously blink, blink in a particular pattern, or the like to indicate that information handling system 102 is in the diagnostic boot mode.

In an example, the headless diagnostic boot mode may be an operation of SoC 122 executing UEFI code to check system power-on health at both a firmware level and a hardware level. In certain examples, during the diagnostic boot, SoC 122 may also verify the initialization status of individual devices that are critical to the UEFI BIOS boot path, any other chipset level catastrophic error, or the like. For example, SoC 122 may perform any suitable checks in the diagnostic boot. These checks may include, but are not limited to, detection of non-random access memory (non-RAM) memory, trusted platform module (TPM) detection failure, unrecoverable serial peripheral interface (SPI) flash failures, non-replay protection monotonic counter (non-RPMC) flash on boot guard fused system, detection of whether a chipset catastrophic error signal has tripped, and invalid memory installed. During the execution of the diagnostics, SoC 122 may determine a failure point in the POST and generate diagnostic failed code associated with the POST failure. In an example, the diagnostic failed code may include data associated with detecting or determining failures of one or more of the checks listed above.

On competition of diagnostics, SoC 122 may provide the generated diagnostic failed code to embedded controller 120. Embedded controller 120 may then combine boot markers 150 with the diagnostic failed code. In response to combining this data, embedded controller may provide the combination of boot marker 150 and the diagnostic code to adapter 104. The communication of the diagnostic failed code and boot markers may be provided via any suitable communication protocol and any suitable communication channels. In an example, EC 120 may utilize an inter-integrated circuit (I2C) communication channel to provide the diagnostic failed code and boot markers to PD controller 124. PD controller 124 may utilize a side band communication, such as the configuration channel (CC) line of USB type-C connectors 126 and 136, between information handling system 102 and charger adapter 104 to provide the diagnostic failed code and boot markers to the charger adapter.

In an example, adapter 104 may execute power delivery firmware service 134 to receive the boot markers and diagnostic code from embedded controller 120. In certain examples, power delivery firmware service 134 may utilize USB interface 132 to receive the boot markers and diagnostic code. In response to the reception of the boot markers and diagnostic code, power delivery firmware service 134 may store the boot markers and diagnostic code in volatile storage 130 for later use.

In an example, adapter 104 may provide the boot markers and diagnostic code to remote server 110 via any suitable path, such as via information handling system 106, mobile device 108, or the like. In certain examples, charger adapter 104 may provide the boot markers and diagnostic code to information handling system 106 when this information handling system is connected to the charger adapter. In response to receiving the boot markers and diagnostic code, information handling system 106 may provide the data to remote server 110. In an example, mobile device 108 may retrieve the boot markers and diagnostic code from charger adapter 104 in any suitable manner, such as through an application executed on the mile device or the like. In response to receiving the boot markers and diagnostic code, mobile device 108 may provide the data to remote server 110.

In certain examples, in information technology (IT) administrator associated with information handling system 102 and remote server 110 may utilize the boot markers and diagnostic code to determine the best course of action to fix the information handling system. In certain examples, the use of the boot markers and diagnostic code may include analyzing the boot markers and diagnostic code to determine any possible failure points in POST.

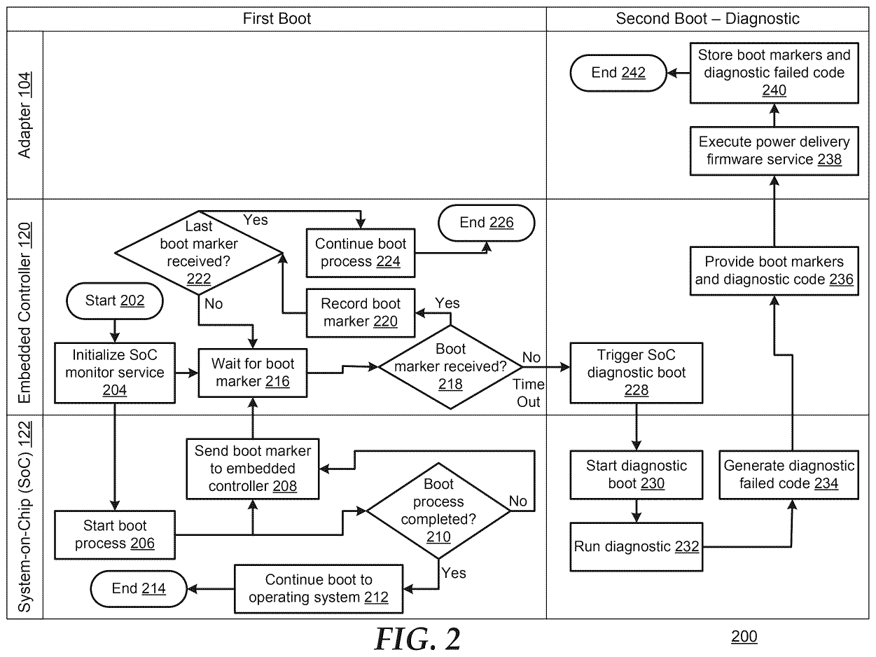

FIG. 2 shows a method 200 for performing diagnostics based on no video mode reported triggers according to at least one embodiment of the present disclosure, starting at block 202. Not every method step set forth in this flow diagram is always necessary, and certain steps of the methods may be combined, performed simultaneously, in a different order, or perhaps omitted, without varying from the scope of the disclosure. FIG. 2 may be employed in whole, or in part, embedded controller 120 of information handling system 100 in FIG. 1, SoC 122 of information handling system 100 in FIG. 1, and charger adapter 104 in FIG. 1, or any other type of controller, device, module, processor, or any combination thereof, operable to employ all, or portions of, the method of FIG. 2.

At block 204, a SoC monitoring service is initialized. In an example, the SoC monitoring service may be a firmware service, or driver, within an embedded controller of an information handling system. In certain examples, the SoC monitoring service may be utilized to monitor operations of a POST boot process executed by a SoC of the information handling system.

At block 206, a POST boot process is begun. In an example, SoC 122 of an information handling system may begin and execute the POST boot process for the information handling system. The POST boot process may include multiple different phases, such as SEC, pre-PEI, DXE, and BDS. At block 208, boot markers are provided to the embedded controller. In an example, different boot markers may indicate the completion of different phases or stages in the POST boot process. At block 210, a determination is made whether the POST boot process is completed. If the boot process is not completed, the flow continues as stated above at block 208. If the POST boot process is completed, the boot process of the information handling system continues to the operating system at block 212 and the flow ends at block 214.

At block 216, after the SoC monitoring service is initialized, embedded controller 120 waits for boot markers from SoC 122 at block 216. At block 218, a determination is made whether a boot marker has been received. In response to a boot marker being received, the boot marker is stored at block 220. At block 222, a determination is made whether the boot marker is the last boot marker to the POST boot process. This determination may be made by the embedded controller of the information handling system. In an example, the embedded controller may determine whether the received boot marker is the last boot marker based on a boot marker table stored in a memory. In certain examples, the boot marker table may be created during the build time of the BIOS and the embedded controller of the information handling system.

If the boot marker is not the last boot marker, the flow continues as stated above at block 216. If the boot marker is the last boot marker, the POST boot process is continued at block 224 and the flow ends at block 226. In an example, blocks 204-224 may be performed during a first or normal boot process of an information handling system. Additionally, blocks 204 and 216-224 may be performed by embedded controller 120 during the first boot process. Similarly, blocks 206-214 may be performed by SoC 120 during the first boot process.

At block 228, a SoC diagnostic boot is triggered. At block 230, the diagnostic boot process is started. At block 232, the diagnostics is run. During the diagnostics, SoC may analyze the boot markers stored by the embedded controller. Based on the boot markers, the SoC may determine one or more failure points of the POST boot process. At block 234, a diagnostic failed code is generated. In an example, the diagnostic failed code

At block 236, the diagnostic failed code and boot markers are provided. In an example, the diagnostic failed code and boot markers may be provided to any suitable device, such as a power adapter connected to the information handling system. At block 238, a PD firmware service is executed. At block 240, the boot markers and diagnostic failed code are stored and the flow ends at block 242. In certain examples, the diagnostic failed code and boot markers may be stored in a memory of the charger adapter. In an example, blocks 228-240 may be performed during a diagnostic boot process of the information handling system. Blocks 228 and 236 may be performed by embedded controller 120 during the diagnostic boot process and blocks 230-234 may be performed by SoC 120 during the diagnostic boot process. Similarly, blocks 238 and 240 may be performed by adapter 104 during the first diagnostic process.

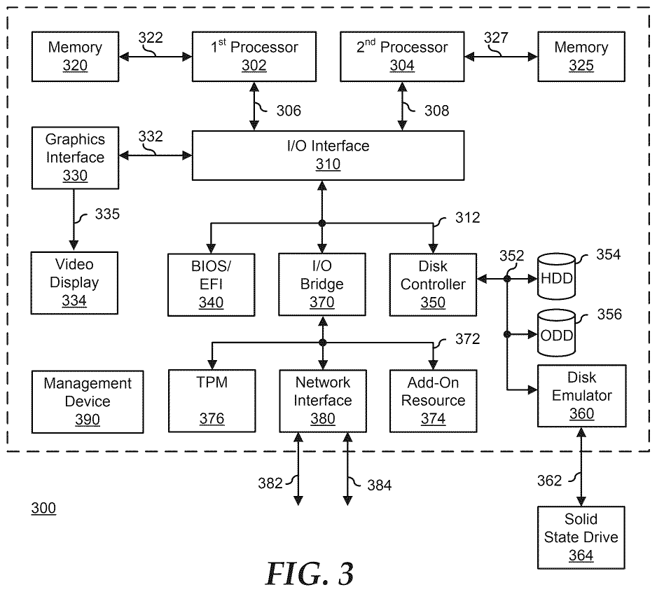

FIG. 3 shows a generalized embodiment of an information handling system 300 according to an embodiment of the present disclosure. Information handling system 300 may be substantially similar to information handling system 102 of FIG. 1. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 364, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 364, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332 and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 4394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312 or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300.

Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a system on a chip (SoC) to:
execute diagnostic boot operations in the information handling system; and
generate a diagnostic code during the diagnostic boot operations; and
a processor to communicate with the SoC, during boot operations of the information handling system, the processor to:
monitor the boot operations being executed by the SoC;
store any boot markers received from the SoC;
determine whether a time out event has occurred before a first boot marker is received or after a most recent boot marker; and
in response to a detection of the time out event, trigger the diagnostic boot operations.

2. The information handling system of claim 1, wherein the diagnostic boot is performed after a completion of the boot operation.

3. The information handling system of claim 1, wherein during the diagnostic boot operations, the processor further to:
receive the diagnostic code from the SoC; and
provide both the diagnostic code and the any boot markers stored during the boot operations.

4. The information handling system of claim 1, wherein the processor further to:
determine whether a last boot marker is received; and
in response to the last boot marker being received, enable the SoC to complete the boot operations.

5. The information handling system of claim 4, wherein the determination of whether the last boot marker has been received is based on a boot table created during an initial set up of the information handling system.

6. The information handling system of claim 1, wherein the SoC further to: periodically provide boot markers to the processor until the boot operations are completed.

7. The information handling system of claim 1, wherein the diagnostic code is associated with a failure of the boot operations determined during the diagnostic boot operations.

8. A method comprising:
monitoring, by an information handling system, boot operations being executed by a system on a chip (SoC) of the information handling system;
storing any boot markers received from the SoC;
determining whether a time out event has occurred before a first boot marker is received or after a most recent boot marker;
in response to a detection of the time out event, triggering a diagnostic boot operations;
executing, by the SoC, the diagnostic boot operations in the information handling system; and
generating a diagnostic code during the diagnostic boot operations.

9. The method of claim 8, wherein the diagnostic boot is performed after a completion of the boot operation.

10. The method of claim 9, wherein during the diagnostic boot operations, the method futher comprises:
receiving, by the processor, the diagnostic code from the SoC; and
providing both the diagnostic code and the any boot markers stored during the boot operations.

11. The method of claim 8, further comprising:
determining whether a last boot marker is received; and
in response to the last boot marker being received, enabling the SoC to complete the boot operations.

12. The method of claim 8, wherein the determination of whether the last boot marker has been received is based on a boot table created during an initial set up of the information handling system.

13. The method of claim 8, further comprising: periodically providing, by the SoC, boot markers to the processor until the boot operations are completed.

14. The method of claim 8, wherein the diagnostic code is associated with a failure of the boot operations determined during the diagnostic boot operations.

15. A system comprising:
an information handling system including:
system on a chip (SoC) to:
execute diagnostic boot operations in the information handling system; and
generate a diagnostic code during the diagnostic boot operations; and
a processor, during boot operations of the information handling system, to:
monitor the boot operations being executed by the SoC;
store any boot markers received from the SoC;
determine whether a time out event has occurred before a first boot marker is received or after a most recent boot marker; and
in response to a detection of the time out event, trigger the diagnostic boot operations; and
an external device to:
receive the diagnostic code from the information handling system; and
store the diagnostic code.

16. The system of claim 15, wherein during the diagnostic boot operations, the processor further to:
receive the diagnostic code from the SoC; and
provide both the diagnostic code and the any boot markers stored during the boot operations to the external device.

17. The system of claim 15, wherein the processor further to:
determine whether a last boot marker is received; and
in response to the last boot marker being received, enable the SoC to complete the boot operations.

18. The system of claim 15, wherein the determination of whether the last boot marker has been received is based on a boot table created during an initial set up of the information handling system.

19. The system of claim 15, wherein the SoC further to: periodically provide boot markers to the processor until the boot operations are completed.

20. The system of claim 15, wherein the diagnostic code is associated with a failure of the boot operations determined during the diagnostic boot operations.
